(19) United States
(12) Patent Application Publication
(10) Pub. No.: US 2003/0101212 A1
(43) Pub. Date: May 29, 2003

(54) Method for automatically completing an electronic form

(76) Inventor: Michael J. Borg, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/991,752

(22) Filed: Nov. 26, 2001

(51) Int. Cl. G06F 15/16; G06F 17/60

(52) U.S. Cl. 709/203; 705/26

(57) ABSTRACT

A method and an apparatus which eliminates repeated entry of user information. A first website corresponding to a vendor of products or services presents (or displays) products or services to a user. A second website along with the first website contains information corresponding to a plurality of individuals. A user browses the first website and selects products or services for purchase. In processing the sale, the first website prompts the user to provide information about the user in order to obtain billing and shipping information for example. The first website includes a software application that is programmed to search a storage medium at the first website. The method and apparatus can also communicate with the second website and search and retrieve information corresponding to the user from the second website based on a minimum amount of information entered through a user interface at the first website. The second website is accessed upon the software application being unable to retrieve information about the user from the first website. The retrieved information is appended to the user entered information and is verified by the user. After verification, the (retrieved and user entered) information is transmitted and processed for completing a transaction.

### FIELD OF THE INVENTION

This invention relates generally to entry of data on electronic forms, and more particularly to automating and simplifying such data entry.

### BACKGROUND OF THE INVENTION

Prior to the widespread use of computers, information forms were filled out by hand, and contained specific spaces for entering specific information. For example, a typical product registration form might have contained spaces for name, address, telephone number, age, income range, type and number of cars owned, hobbies, etc. With the proliferation of computers into virtually every aspect of society, completion of forms, in an electronic form on a computer has become a common practice. These computerized forms often include many different blanks for users to fill out

Electronic forms have been adapted for various uses. The advent of the internet has made commercial transactions via the computer a reality. Such commercial activity is referred to as electronic commerce (or, e-commerce). Electronic forms play a prominent role in e-commerce. A typical e-commerce transaction may proceed as follows: A user or customer visits a website where products, such as computers for example, are sold. The user browses the website that may contain information, including price, on a plurality of products. Such a presentation of products 110, 120, 130 and 140 on a website is illustrated in FIG. 1(a). Additional details or information on products may be accessed by clicking on a hyperlink such as one of the hyperlinks 115, 117 and 119 for example (or by clicking on a button in some settings). An example of such additional information is illustrated in FIG. 1(b) and may also include technical specifications, special sales, etc. The user may then wish to purchase one or more of the products offered for sale on the website as illustrated in FIG. 1(c). A product may be selected (using a mouse for example) by the user to indicate an intent to buy the selected product(s) as illustrated in FIG. 1(c). As a user selects products for purchase, they may be displayed to the user in a format that may be visually similar to a spreadsheet or the like as illustrated in FIG. 1(d). A quantity of the selected product, if greater than one, may also be selected as illustrated in FIG. 1(d). A user's information also has to be entered for identification and shipping purposes for example as illustrated in FIG. 1(e).

FIG. 2(a) illustrates a conventional electronic form for entering user information. User information typically includes name, address, city, state, zip, telephone number, email address, etc. A separate form, such as that illustrated in FIG. 2(b) for example, may be used to store a user's credit card/payment information and other personal information. Other personal information may include, but is not limited to, social security number, blood type, mother's maiden name, etc. Personal information is confidential and is usually provided only by the user or with the user's consent. Such personal information is submitted via a secure connection in order to prevent others from accessing it (i.e., the personal information). On the other hand, more general information about a user (or a customer) such as name, address, etc. may more readily and easily be available from sources other than the user.

Some regular or repeat customers of a particular vendor website may choose to have their information stored in a vendor database during an initial purchase or visit so that this information need not be provided again on a subsequent visit. Vendors typically provide a user with the option of storing the user's general (and, even confidential personal) information at their respective website (referred to herein as a company or vendor website). The forms used for entering such information may resemble those illustrated in FIGS. 2(a) and 2(b). While this approach provides some relief to users who visit a particular website frequently, visits to multiple websites still require repeated entry and submission of user information. For users who browse and purchase products or services from several companies' websites, however, the process of repeatedly having to provide the more general information to various websites becomes a burdensome task.

### SUMMARY OF THE INVENTION

In one aspect, the invention is a method for automating portions of a data entry process. The method comprises entering of information by a user at a first location, accessing a storage medium at a second location that contains information for a plurality of users, utilizing the entered information to identity a user corresponding to the entered user information and retrieving additional information pertaining to the user from the storage medium based on the determined identity.

In other aspect, the invention is a method and a system for eliminating repeated entry of user information at a plurality of locations. The system comprises a first website corresponding to a vendor of products or services, a second website having a storage medium containing information corresponding to a plurality of individuals, a network; and a user station connected to a network, the first website comprising a software application being programmable to communicate with the second website and to search and to retrieve information from the storage medium at the second website in response to information entered through a user interface at the first website

In yet another aspect, the invention is a method for providing a user with control over what information pertaining to the user is to be transmitted over a network.

In comparison to known prior art, certain embodiments of the invention are capable of achieving certain aspects, including some or all of the following: (1) methods and apparatus are capable of converging to a better solution than prior art solutions; and (2) the methods and apparatus are capable of performing some tasks more easily than possible before. Those skilled in the art will appreciate these and other advantages and benefits of various embodiments of the invention upon reading the following detailed description of a preferred embodiment with reference to the below-listed drawings.

### BRIEF DESCRIPTION OF THE DRAWINGS

FIGS. 1(a)-1(e) illustrate a typical electronic commerce transaction between a customer and a vendor website where products and information from the vendor are offered for sale;

FIGS. 2(a) and 2(b) illustrate conventional electronic forms for entering general information and personal information for a user;

FIG. 3 illustrates a respective relationship between the various websites and a customer according to exemplary embodiments of the present invention; and

FIG. 4 illustrates a method for automating entry of customer information according to exemplary embodiments of the present invention.

### DETAILED DESCRIPTION OF A PREFERRED EMBODIMENT

At least the shortcomings highlighted above may be overcome by exemplary embodiments of the invention.

Existing systems facilitate centralized storage of information for multiple individuals. This information may be stored in a database for example. There are at least two examples of websites that facilitate storage and maintenance of such systems. These websites are http://www.switchboard.com and http://www.people.yahoo.com. Each of these systems provide users with the ability to enter and edit or modify general information about themselves. This information may then be saved (stored). Once this information is stored, it may be accessed by other users who may log onto these websites and retrieve information about an individual by entering a last name, for example. These websites make this information available to the public much like a directory. Any information provided by an individual to these websites is available to the public if the individual's last name is known and entered. These websites may be referred to herein as data websites.

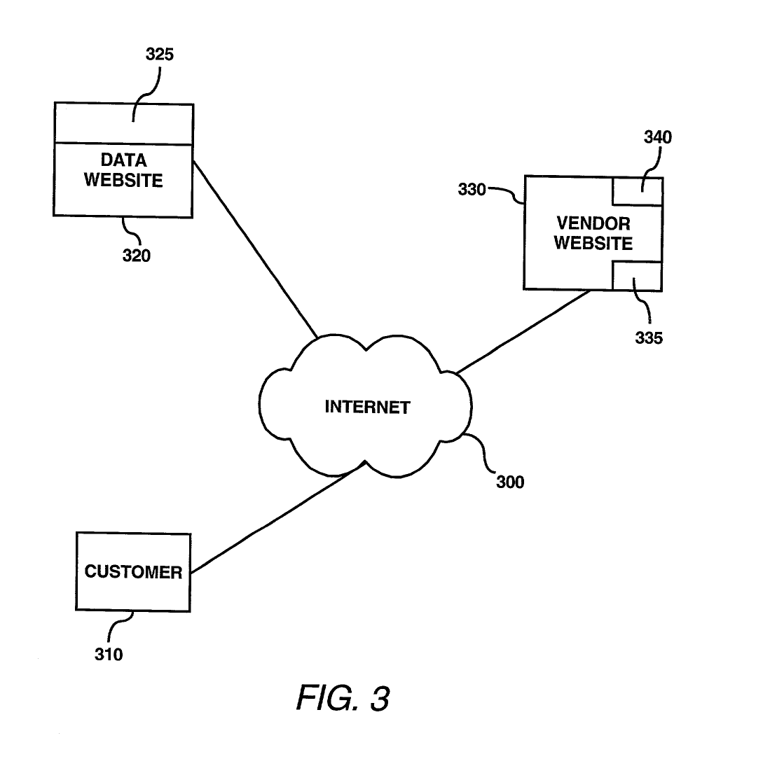

According to exemplary embodiments of the present invention, information stored at the data websites may be accessed from or by the vendor websites. Data websites such as website 320 of FIG. 3 may be connected to the Internet 300 along with vendor websites such as vendor website 330 and a user (or customer) 310 as illustrated in FIG. 3. The user 310 may interact with the data and vendor websites 320 and 330 via an interface such as a keyboard, a mouse, a graphical user interface or the like.

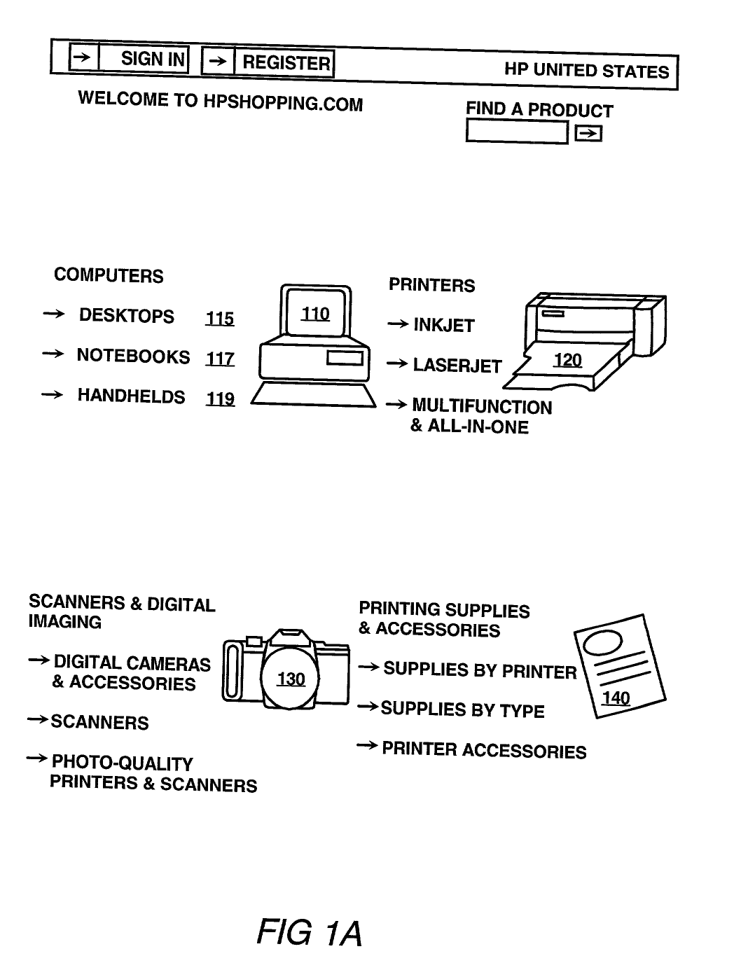

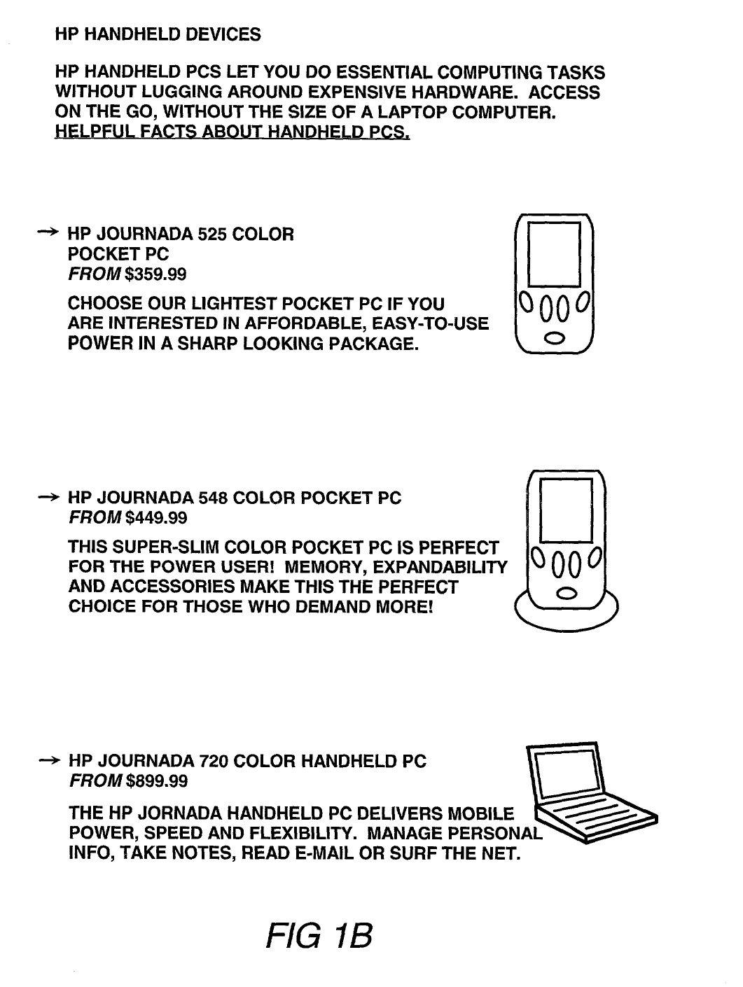

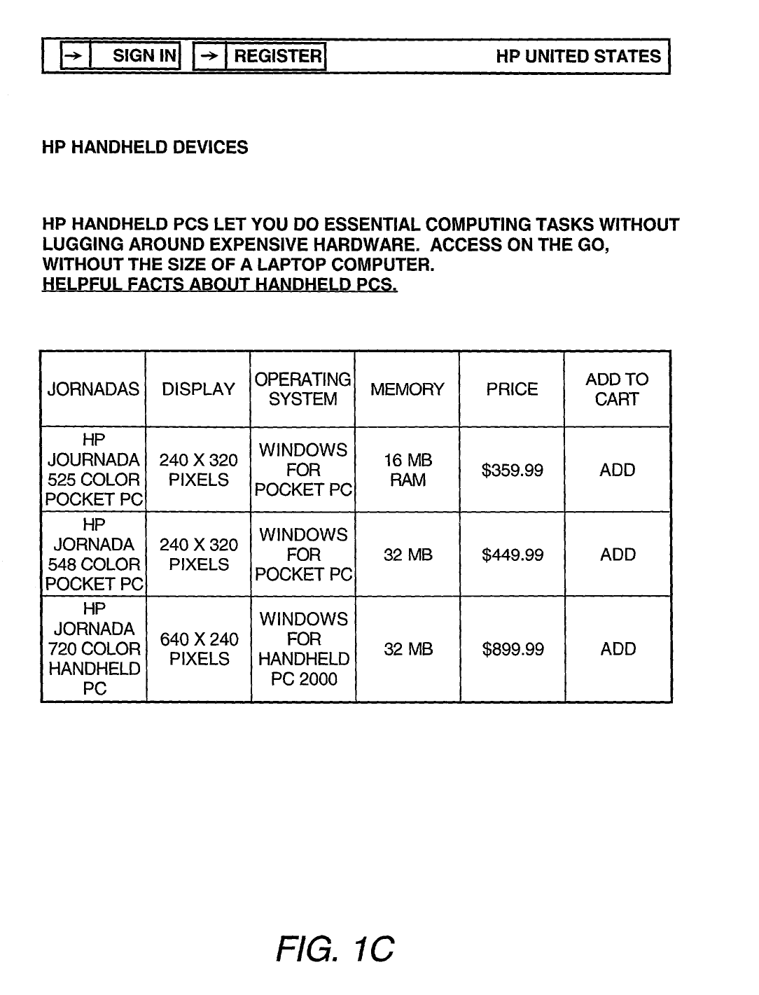

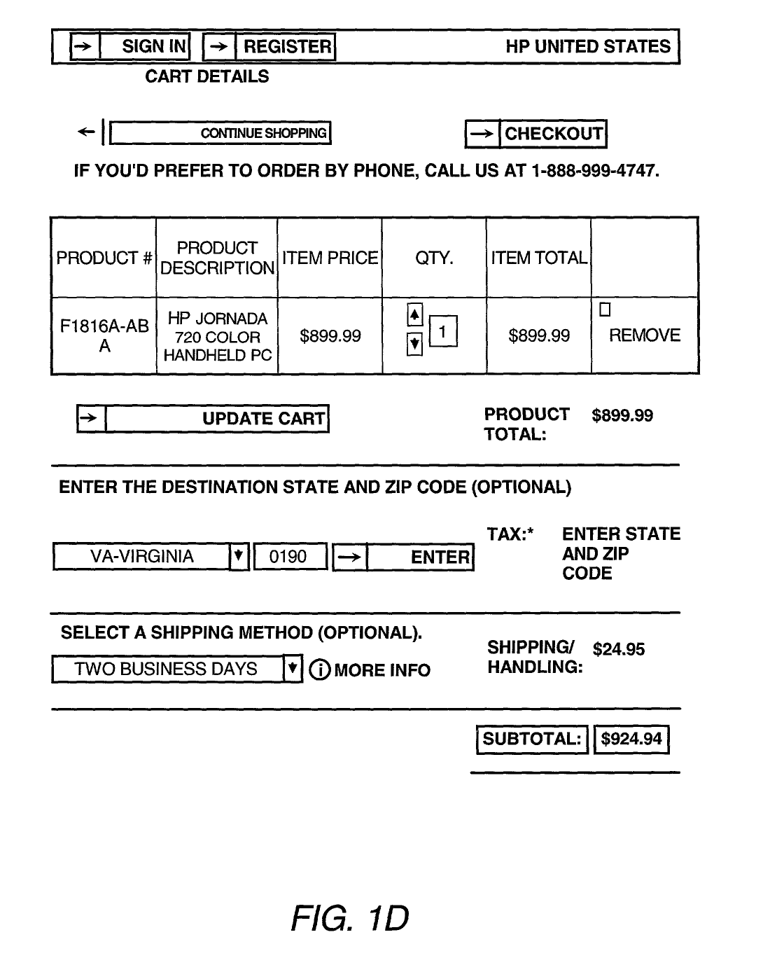

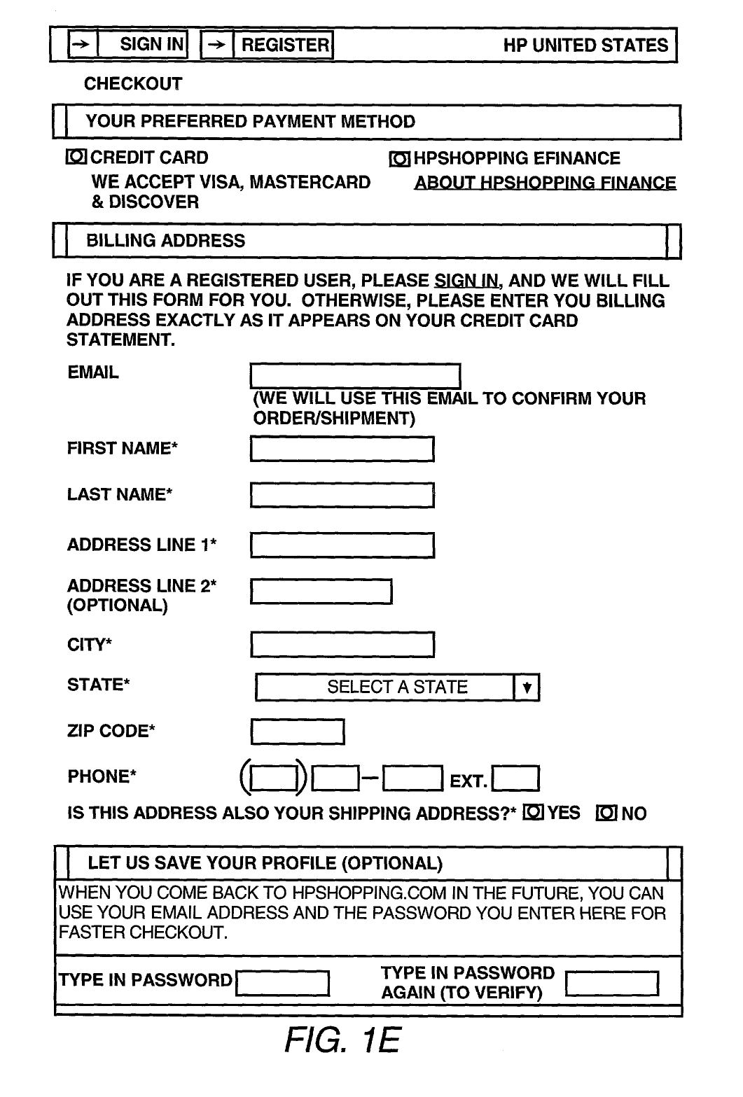

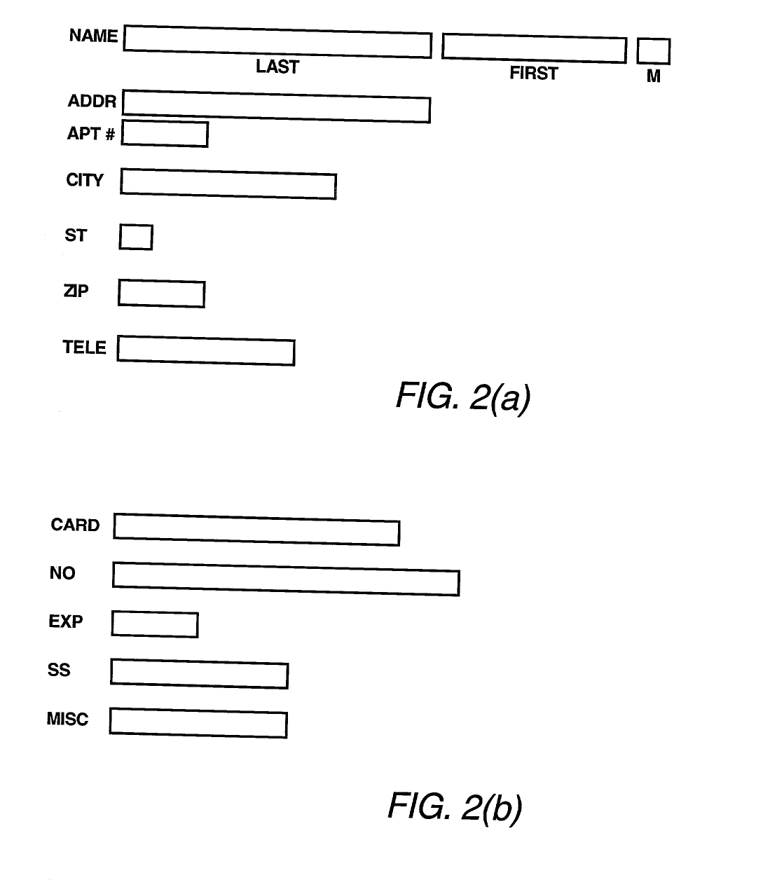

Communication between the respective websites (i.e., vendor 330 and data 320) is facilitated by a software application 335 at the vendor website 330. This software may be a browser plug-in module, for example. A typical visit by a customer 310 to a vendor website 330 (or, browsing on the vendor website 330) may include the following interaction between the user/customer 310 and the vendor website 330 according to exemplary embodiments of the present invention. Upon selecting a number of items or services for purchase from a vendor, the customer 310 encounters a form containing fields for entering the customer's general information similar to that illustrated in FIG. 1(e).

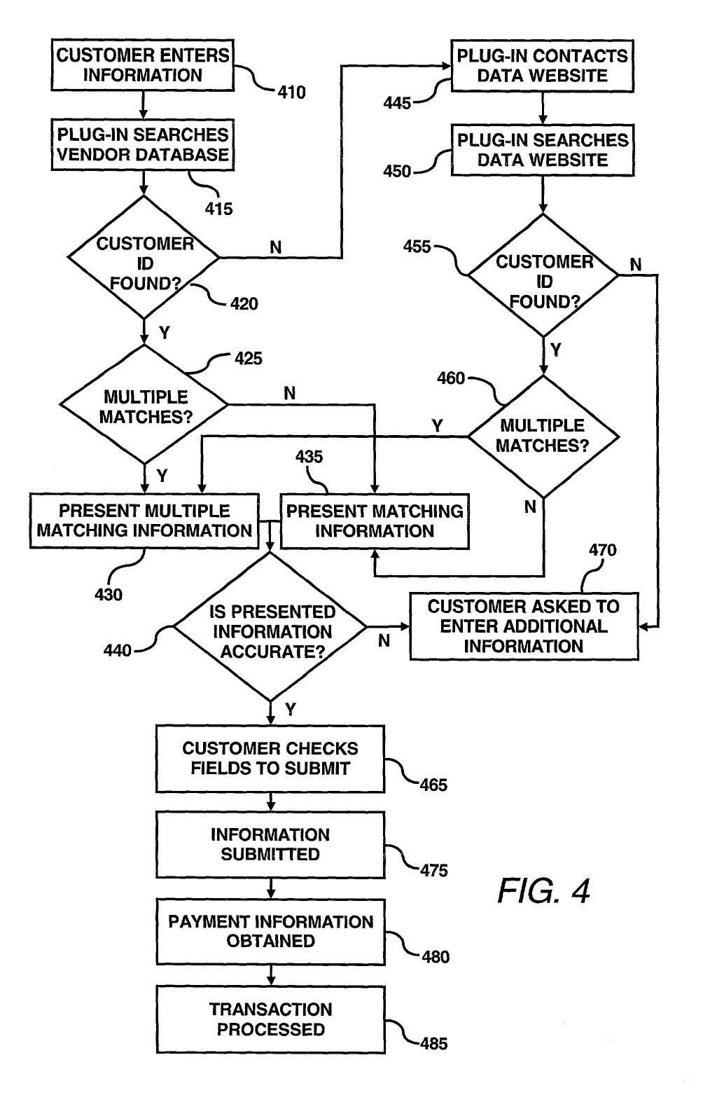

A method for automating entry of a customers or user information according to exemplary embodiments of the present invention is illustrated in FIG. 4. The user or customer 310, at step 410, may begin entering information such as an e-mail address, last name, zip code, etc. Upon entry of a predetermined, minimum number of required fields, the browser plug-in module 335 (of FIG. 3), at 415, may initiate a search of a database associated with the particular vendor website 330 such as vendor database 340 in order to determine the customer's identity. The minimum information required may be set to include last name and zip code. If an e-mail address is used as the identifying information, this one field may be adequate as an e-mail address is deemed to be unique to a particular user. In searching for a user (or, customer) identification in the vendor database, the module 335 may locate one matching customer or a number of matching customers using the information entered at step 410. If the module 335 determines that a match is found within the vendor's database at 420, then the module has to determine whether there are multiple matches at step 425. If there are multiple matches, then the multiple matches are presented to the customer at step 430. If there is only one matching information on the other hand, the matching information is presented at step 435. The presented information (either from step 430 or 435) is verified for accuracy at step 440. If the information is correct, the customer checks the fields that the customer wishes to submit at step 465. If the customer determines that the information is not correct, the customer is prompted to enter accurate (or, additional) information at 470.

If, on the other hand, no match is found within the vendor database at 420, the module 335 may then initiate communication with the data website 320 at 445 in order to determine the customer's identity. The plug-in module 335, using the information entered in the minimum number of fields, searches an archival (or, storage) medium 325 (of FIG. 3) of the data website 320 (of FIG. 3) at 450 to obtain additional information about the customer 310. If the module 335 determines at 455 that a match is found, then the module has to determine whether there are multiple matches at step 460. If there are multiple matches, then the multiple matches are presented to the customer at step 430. If there is only one matching information on the other hand, the matching information is presented at step 435. The presented information (either from 430 or 435) is verified for accuracy at step 440. If the information is correct, the customer checks the fields that the customer wishes to submit. If the customer determines that the information is not correct, the customer is prompted to enter accurate (or, additional) information at 470.

If the module determines at 455, that no match for the customer has been found, the customer is prompted to enter accurate (or, additional) information at 470.

In addition to selecting fields to submit, the customer may be provided with an option to select only those fields of information that the customer wishes to transmit to the vendor at 465. In order to achieve this selective transmission of information, a check box may be placed next to each field. The customer may check the boxes that correspond to the type of information that the customer wishes to transmit. For example, a customer may not wish to provide demographic information to some vendors or telephone number to other vendors. The information presented to the user at 430 (and/or 435) may be more extensive than that which is needed to process a customer's purchase order. For example, the information may include demographic information about the customer such as age range, household income level, number of cars owned, etc. In an alternative arrangement, a user may be given an opportunity to check one box to transmit all information that is presented. It is to be understood that a customer cannot refuse to transmit information that is required. Once the customer information is entered at 470 or when the customer has verified the accuracy of the located information at 440 and selected fields for submission at 465, the information is submitted at 475. Payment information may be obtained at 480 and the transaction is processed at 485.

While a vendor website in the present invention has been described as that of a particular company, etc. offering its products and services for sale, it could also be a website where products and services from multiple vendors and/or companies may also be offered.

By communicating with a data website as described, the present invention makes the process of providing customer information less burdensome to the customer.

Exemplary embodiments of the present invention may be realized on a system that includes vendor websites and data websites as described and the internet. Customers that visit multiple websites to conduct commercial transactions may now store their information at a central location from which it may be obtained by a plurality of vendor websites. These central data websites also have an incentive to facilitate such storage as an extensive collection of user information leads to increase advertising revenue for the data websites.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. An automated data entry method comprising:
entering a user information at a first location;
searching a storage medium at said first location to determine an identity of a user based on the entered information;
accessing a storage medium at a second location upon not being able to identify a user by searching the storage medium at said first location, said medium at the second location containing information for a plurality of users;
searching the storage medium at the second location to determine an identity of said user based on the entered information; and
retrieving additional information pertaining to the user from the storage medium at the first or second locations based on the determined identity.

2. The method of claim 1 further comprising:
establishing communication from the first location to the second location by a programmable software application at the first location.

3. The method of claim 2 wherein said software application is a browser plug-in module.

4. The method of claim 1 wherein the first and second locations are connected to a network.

5. The method of claim 4 wherein the network is the Internet.

6. The method of claim 1 wherein the first and second locations are websites.

7. The method of claim 6 wherein said first website is associated with a vendor.

8. The method of claim 1 wherein the retrieved additional information is presented to the user for verifying accuracy of said information.

9. The method of claim 8 further comprising the steps of:
verifying an accuracy of said retrieved additional information,
appending the additional information to the entered user information;
transmitting said entered information and said appended additional information; and
processing said transmitted information to complete a transaction.

10. The method of claim 9 wherein the user selects portions of the additional information for transmission.

11. The method of claim 2 wherein the application is further programmable to search a database associated with the first location.

12. A system comprising:
a first website corresponding to a vendor of products or services, said first website having a storage medium containing information corresponding to a plurality of individuals;
a second website having a storage medium containing information corresponding to a plurality of individuals;
a network connecting said websites; and
a user station connected to the network, the first website comprising a software application being programmable to communicate with the second website and to search and to retrieve information from the storage medium at the first and second websites in response to information entered through a user interface of the user station.

13. The system of claim 12 wherein the network is the Internet.

14. The system of claim 12, wherein said first website presents a plurality of products or services offered by a vendor.

15. The system of claim 14, wherein said first website includes links to additional information pertaining to said products or services.

16. The system of claim 12, wherein said first website facilitates a transaction between the user and the vendor.

17. The system of claim 12, wherein said first website contains information pertaining to a plurality of users.

18. The system of claim 12, wherein the user selects at least one product or service for purchase from the vendor.

19. The system of claim 18, wherein a user selection is displayed to the user.

20. The system of claim 19, wherein the user is prompted to enter information for shipping and billing purposes.
